(19) United States
(12) Patent Application Publication
(10) Pub. No.: US 2010/0253819 A1
(43) Pub. Date: Oct. 7, 2010

(54) SOLID STATE IMAGING DEVICE AND METHOD FOR MANUFACTURING THE SAME

(75) Inventor: Kenji YOKOZAWA, Shiga (JP)

Correspondence Address: MCDERMOTT WILL & EMERY LLP, 600 13TH STREET, NW, WASHINGTON, DC, 20005-3096, US

(73) Assignee: Panasonic Corporation, Osaka (JP)

(21) Appl. No.: 12/816,752

(22) Filed: Jun. 16, 2010

Related U.S. Application Data
(63) Continuation of application No. PCT/JP2009/001968, filed on Apr. 30, 2009.

(30) Foreign Application Priority Data
Jul. 25, 2008 (JP) 2008-192240

(51) Int. Cl. H04N 5/335

(52) U.S. Cl. 348/273; 348/E05.091

(57) ABSTRACT

A solid state imaging device includes: a plurality of photoelectric conversion elements arranged in a matrix pattern on a semiconductor substrate; a wall portion provided above a region between the plurality of photoelectric conversion elements; and a plurality of color filter portions provided above the photoelectric conversion elements so as to fill openings surrounded by the wall portion. The wall portion is formed from a dye containing resist.

### CROSS-REFERENCE TO RELATED APPLICATION

This is a continuation of PCT International Application PCT/JP2009/001968 filed on Apr. 30, 2009, which claims priority to Japanese Patent Application No. 2008-192240 filed on Jul. 25, 2008. The disclosures of these applications including the specifications, the drawings, and the claims are hereby incorporated by reference in its entirety.

### BACKGROUND

Color solid state imaging devices have a color filter layer in order to provide color images. In the color filter layer, color filter portions (colorant layers) of colors corresponding to photoelectric conversion elements are arranged in a predetermined pattern (e.g., Japanese Published Patent Application No. 2006-163316, hereinafter referred to as “Document 1”). The color filter layer used in the color solid state imaging devices is formed by applying, e.g., a photosensitive resin having a coloring material (such as a pigment or dye) dispersed therein, to a substrate, and exposing, developing, and curing the photosensitive resin.

A color solid state imaging device of a related art having a color filter layer as disclosed in Document 1 will be described with reference to the figures. FIGS. 16A-16B are diagrams illustrating a color solid state imaging device 100 having color filter portions of each color arranged so as to correspond to each pixel. FIG. 16A is a plan view mainly showing a color filter layer 122, and FIG. 16B is a cross-sectional view of the color solid state imaging device 100 taken along line XVIb-XIVb' in FIG. 16A.

Single-plate color solid state imaging devices are solid state imaging devices that provide color images by using color filters corresponding to three primary colors of light in a single solid state imaging device. Such single-plate color solid state imaging devices typically use a color filter layer in which color filter portions of each color are arranged in a Bayer pattern. The color filter layer 122 of FIG. 16A is also a color filter layer having the Bayer pattern.

As shown in FIG. 16A, in the color filter layer 122, green filter portions 122G are arranged in a checkered pattern, and blue filter portions 122B or red filter portions 122R are alternately arranged in each row or column so as to fill the remaining regions. That is, green and blue are alternately arranged in a certain row (e.g., the row of line XVIb-XVIb' in FIG. 16A), and red and green are alternately arranged in the rows adjoining this row. Similarly, green and blue are alternately arranged in a certain column, and red and green are alternately arranged in the columns adjoining this column. Each filter portion of each color is positioned corresponding to a pixel. Note that a circular microlens 124 and an opening region 117a, which will be described later, are also shown in each pixel to illustrate their positions and shapes. The opening regions 117a are regions that are not covered by a light shielding film 117.

As shown in the cross-sectional view of FIG. 16B, the color solid state imaging device 100 is formed by using an N-type semiconductor substrate 111.

A P-well layer 112 is formed on the N-type semiconductor substrate 111. A plurality of photoelectric conversion elements 113 for performing photoelectric conversion are formed as N-type semiconductor layers in the upper part of the P-type well layer 112. Each photoelectric conversion element 113 is included in a corresponding one of pixels. A gate insulating film 114 is formed so as to cover the P-type well layer 112 and the photoelectric conversion elements 113. Transfer electrodes 115 for transferring signals are formed between the photoelectric conversion elements 113 on the gate insulating film 114.

An interlayer insulating film 116 is formed on the side and upper surfaces of each transfer electrode 115. Thus, each transfer electrode 115 is covered by the interlayer insulating film 116. The light shielding film 117 is formed so as to cover the interlayer insulating film 116. The light shielding film 117 is made of tungsten or the like, and serves to block unnecessary incident light on the portions other than the photoelectric conversion elements 113.

A surface protective film 118 is formed so as to cover the gate insulating film 114 and the light shielding film 117. Since the surface protective film 118 is formed on the uneven underlying surface, the surface protective film 118 has recesses above the photoelectric conversion elements 113. First transparent planarizing films 119 are formed so as to fill the recesses of the surface protective film 118. The upper surface of the surface protective film 118 is made flush with the upper surfaces of the first transparent planarizing films 119.

Then, a second transparent planarizing film 120, which is made of a thermosetting transparent resin, is formed on the surface protective film 118 and the first transparent planarizing films 119. A color filter layer 122 is formed on the second transparent planarizing film 120. The second transparent planarizing film 120 functions to increase adhesion of the color filter layer 122, and to reduce the amount of development residue in the manufacturing process.

The color filter layer 122 is a collection of color filter portions each containing a predetermined colorant (green, blue, or red in this example), namely a collection of the green filter portions 122G, the blue filter portions 122B, and the red filter portions 122R. These color filter portions are arranged in the pattern shown in FIG. 16A. Note that each color filter portion is positioned above a corresponding one of the photoelectric conversion elements 113.

A third transparent planarizing film 123 is formed on the color filter layer 122, and the microlenses 124 corresponding to each pixel are formed on the third transparent planarizing film 123. The third transparent planarizing film 123 is provided in order to accurately form the microlenses 124. The microlenses 124 function to increase light collection efficiency to the color filter portion and the photoelectric conversion element 113 in each pixel.

In the solid state imaging device described in Document 1, the total area occupied by the green filter portions 122G in an imaging region is the largest among all of the filter portions (the green filter portions 122G, the red filter portions 122R, and the blue filter portions 122B). Thus, when forming the color filter layer 122, the green filter portions 122G are first formed as a first layer. The green filter portions 122G are formed on the second transparent planarizing film 120 so as to connect together in the corners of the pixels, and to form openings at positions corresponding to blue and red. The green filter portions 122G are formed so that their width is larger than the widths of the blue filter portions 122B and the red filter portions 122R.

Of the openings between the green filter portions 122G, those corresponding to blue are selectively filled with a photosensitive colored resin containing a blue pigment. Then, the photosensitive colored resin is exposed, developed, and cured by using a predetermined photomask, thereby forming the blue filter portions 122B each surrounded by the green filter portions 122G.

Then, the openings corresponding to the red filter portions 122R are filled with a photosensitive colored resin containing a red pigment, and processes similar to those for forming the blue filter portions 122B are performed to form the red filter portions 122R each surrounded by the green filter portions 122G.

The shapes of the blue filter portions 122B and the red filter portions 122R formed in this manner are defined by the shape of the openings formed in the green filter portions 122G. Thus, exposure patterns of the photomasks for forming the blue filter portions 122B and the red filter portions 122R need only be designed so as to surround the openings, and need not exactly match the shape of the openings. This reduces required alignment accuracy of the photomasks.

The green filter portions 122G, which are formed by using the photomask designed as described above, have a width larger than the widths of the blue filter portions 122B and the red filter portions 122R. Thus, the green filter portions 122G stably connect together in their corners. The use of such a manufacturing method can prevent or reduce generation of gaps and overlaps between the color filters, and thus can reduce the possibility of color mixture, sensitivity unevenness, and the like.

Note that a technique relating to color filters is described also in Japanese Published Patent Application No. 2005-5419 and the like.

### SUMMARY

The above color filter layer 122 has the following problems.

Firstly, the green filter portions 122G need to have a thickness larger than that of the photosensitive colored resin (containing a blue pigment) that is applied to form the blue filer portions 122B, and the photosensitive colored resin (containing a red pigment) that is applied to form the red filter portions 122R. Otherwise, when applying the photosensitive resist containing a blue or red pigment after forming the green filter portions 122G, the photosensitive resist is applied not only to the openings but also to the upper surfaces of the green filter portions 122G. Thus, high alignment accuracy is required for the photomasks. Misalignment of the photomasks needs to be avoided since it causes overlaps of the color filter portions, resulting in color mixture.

Thus, the thickness of the green filter portions 122G needs to be larger than that of the blue filter portions 122B and the red filter portions 122B, which restricts spectral characteristics of the color filters that are used for color solid state imaging devices.

Pigment dispersion filters are widely used as color filters of color solid state imaging devices, due to their high light resistance and high heat resistance. The pigment dispersion filters are obtained by solidifying photosensitive resins having a pigment dispersed therein (hereinafter referred to as the “pigment dispersion resists”). However, the pigment dispersion resists have a lower resolution than that of normal photoresists because light is scattered by pigment particles in an exposure process. Thus, it becomes increasingly difficult to use the pigment dispersion resists in miniaturized applications, and to form color filter layers capable of providing high definition images.

FIGS. 17A-17B show examples of miniaturized pigment dispersion green filter portions 122G. In these examples, the green filter portions 122G have round edges due to the low resolution of the pigment dispersion resist, and openings 122a for forming blue filter portions 122B and red filter portions 122R have a circular shape. FIG. 16A shows the color filter layer 122 in which the filters of each color are substantially square. However, as the solid state imaging devices are miniaturized, it becomes increasingly difficult to form such a color filter layer 122.

Note that FIGS. 17A-17B show two examples of the openings 122a with different sizes. More specifically, in the example of FIG. 17A, the green filter portions 122G are formed in the regions above the photoelectric conversion elements 113 and in the regions above the light shielding film 117 located between the photoelectric conversion elements 113, and the openings 122a are small. In the example of FIG. 17B, the green filter portions 122G have the same width as that of the photoelectric conversion elements 113, and the openings 122a are large.

FIGS. 18A-18B show a color solid state imaging device 100 having the green filter portions 122G of FIG. 17A, and FIGS. 19A-19B show a color solid state imaging device 100 having the green filter portions 122G of FIG. 17B. Like reference characters represent like elements in FIGS. 16A-16B and FIGS. 18A-18B and 19A-19B.

As described above, the function of the color filter layer 122 is not impaired if the green filter portions 122G are not displaced with respect to the pixels.

Note that, when the green filter portions 122G have the largest width as shown in FIG. 18A, the green filter portions 122G overlap the corners of the photoelectric conversion elements 113 corresponding to the blue filter portions 122B or the red filter portions 122R, even if there is no displacement of the green filter portions 122G. However, this hardly affects the function since, strictly speaking, the photoelectric conversion elements 113 have round corners.

When forming the green filter portions 122G, the green filter portions 122G can be displaced with respect to the pixels. FIGS. 20A-20B shows an example in which the green filter portions 122G of FIGS. 17A-17B are displaced in one direction (to the right in the figures).

As shown in FIG. 20A, if the green filter portions 122G have a large width, the green filter portions 122G greatly overlap those photoelectric conversion elements 113a over which the openings 122a should be located. Thus, when forming the blue filter portions 122B and the red filter portions 122R, color mixture occurs as shown in FIGS. 21A-21B.

FIG. 21A is a plan view, and FIG. 21B is a cross-sectional view taken along line XXIb-XXIb′ in FIG. 21A. In this case, for example, light 152, which has passed through the green filter portion 122G, is incident on the photoelectric conversion element 113a on which light 151, which has passed through the blue filter portion 122B, should be incident. A similar problem occurs in the pixels having the red filter portions 122R. As shown in FIG. 20B, if the green filter portions 122G have a small width, the openings 122a overlap those photoelectric conversion elements 113b over which the green filter portions 122G should to be located. Thus, when forming the blue filter portions 122B and the red filter portions 122R, color mixture occurs as shown in FIGS. 22A-22B. FIG. 22A is a plan view, and FIG. 22B is a cross-sectional view taken along line XXIIb-XXIIb′ in FIG. 22A. In this case, for example, light 154, which has passed through the blue filter portion 122B, is incident on the photoelectric conversion element 113b on which light 153, which has passed through the green filter portion 122G, should be incident. Similarly, light, which has passed through the red filter portion 122R, is incident on another photoelectric conversion element 113.

As the solid state imaging devices are miniaturized, the resolution of the pigment dispersion resists becomes insufficient, and the openings 122a have a round shape. Thus, color mixture tends to occur due to a displacement of the green filter portions 122G. It is one of the objects of the present disclosure to solve this problem.

Note that FIGS. 23-25 show the relations between the width of the green filter portions 122G and the alignment margin of the photomask for forming the green filter portions 122.

FIG. 23 shows the case where the green filter portions 122G have the largest possible width. That is, the green filter portions 122G extend not only above predetermined photoelectric conversion elements 113 but also above the light shielding film 117 that covers the transfer electrodes 115 located on both sides of each of the predetermined photoelectric conversion elements 113. In this case, even a slight displacement of the green filter portions 122G causes the green filter portions 122G to overlap those photoelectric conversion elements 113 which should have the blue filter portions 122B or the red filter portions 122R, resulting in color mixture. That is, in this case, there is no alignment margin for a photomask 161 for forming the green filter portions 122G.

FIG. 24 shows the case where the green filter portions 122G have the smallest width. That is, the green filter portions 122G extend only above the predetermined photoelectric conversion elements 113. In this case, even a slight displacement of the green filter portions 122G causes the blue filter portions 122B or the red filter portions 122R to overlap those photoelectric conversion elements 113 which should have the green filter portions 122G, resulting in color mixture. In this case as well, there is no alignment margin for the photomask 161 for forming the green filter portions 122G.

FIG. 25 shows the case where the largest alignment margin 162 is obtained. In FIG. 25, green filter portions 122Ga and a photomask 161a show the case where the photomask 161 is displaced to the right to the greatest extent possible, and green filter portions 122Gb and a photomask 161b show the case where the photomask 161 is displaced to the left to the greatest extent possible. In these cases, the width of the green filter portions 122G is the same as that of the pixels, namely the sum of the width of the predetermined photoelectric conversion element 113 and the width of the light shielding film 117 that covers one transfer electrode 115. No color mixture occurs if the green filter portions 122G are formed in this range.

As described above, the largest alignment margin for the photomask is obtained in the case where the width of the green filter portions 122G is the same as the pixel width in the color solid state imaging device 100. However, in practical applications, the green filter portions 122G need to have a larger width than the pixel width in order to accurately form the openings 122a surrounded by the green filter portions 122G.

Note that although the side surfaces of the green filter portions 122G extend perpendicularly in FIGS. 21B, 22B, and 23-25, the green filter portions 122G are shown in a simplified manner in these figures. In the case of using a pigment dispersion resist, the side surfaces of the green filter portions 122G typically extend obliquely as shown in FIG. 16B. This is also because light is scattered by the pigment particles contained in the resist in the exposure process.

Dye containing resists, having a dye dispersed in a photosensitive resin, are also used as a color filter material in addition to the pigment dispersion resists. Since the dye containing resists include no particle in the resin, the resolution that is about the same as that of commonly used photoresists can be obtained by the dye containing resists. However, since the dye containing resists have lower light resistance, lower heat resistance and the like as compared to the pigment dispersion resists, the use of the dye containing resists as a color filter material of the color solid state imaging devices is limited. That is, the pigment dispersion resists cannot merely be replaced with the dye containing resists.

In view of the above problems, a color solid state imaging device, which is capable of easing or eliminating restrictions on spectral characteristics of color filter portions, and is also capable of reducing or preventing a reduction in image quality, and which has a color filter layer capable of being used in miniaturized applications, and a manufacturing method thereof will be described below.

A solid state imaging device of the present disclosure includes: a plurality of photoelectric conversion elements arranged in a matrix pattern on a semiconductor substrate; a wall portion provided above a region between the plurality of photoelectric conversion elements; and a plurality of color filter portions provided above the photoelectric conversion elements so as to fill openings surrounded by the wall portion, wherein the wall portion is formed from a dye containing resist.

According to such a solid state imaging device, each of the color filter portions provided above the photoelectric conversion elements is surrounded by the wall portion provided above the region between adjoining ones of the photoelectric conversion elements. A color filter layer is formed by the plurality of color filter portions and the wall portion.

The wall portion is a portion that is provided so as to protrude from the underlying surface, and serves to separate the color filter portions from each other, and is not a portion that functions as a color filter. Although the green filter portions in the color filter layer of the related art needs to be formed from a pigment dispersion resist, the color filter portions of the above solid state imaging device can be formed from other materials such as a commonly used resist material and a dye containing resist. That is, the wall portion can be formed from a material having a higher resolution than that of the pigment dispersion resist. Thus, the wall portion can be accurately patterned in a desired shape even if the solid state imaging device is further miniaturized.

Such a wall portion surrounds the regions located above the photoelectric conversion elements, thereby forming the openings. The color filter portions of each color are formed so as to fill the openings. Thus, the shape of the color filter portions is determined by the shape of the wall portion. As a result, even if the color filter portions are formed from a material having a low resolution, the color filter portions can be formed without reducing pattern accuracy. When forming the color filter portions, an exposure pattern of a photomask can be designed so as to surround the openings. This makes the accuracy requirement for the shape and alignment of the photomask less strict.

The relation of the thickness among the color filters of the colors is not limited. That is, there is no limitation such as that the color filter portions of a certain color need be thicker than those of the other colors. This eases restrictions on spectral characteristics of the color filter portions as compare to examples of the related art.

Since the wall portion is colored, incident light on the wall portion can be absorbed, reducing the amount of the incident light entering the photoelectric conversion elements due to irregular reflection. This can reduce noise such as smear. In particular, since the dye containing resist has a high resolution, the dye containing resist is capable of being patterned with a satisfactory edge shape (is capable of forming a wall portion whose side surfaces extend perpendicularly to a substrate), and is capable of achieving high dimensional accuracy, even if the line width of the pattern is as small as, e.g., 0.4 μm or less. Thus, the dye containing resist is useful as a material of the wall portion.

Note that the plurality of color filter portions may have a height equal to or less than that of the wall portion.

This can reduce or eliminate the possibility that the color filter portions of each color may extend on an upper surface of the wall portion, may extend over the photoelectric conversion elements other than those over which the color filter portions should be formed, and the like, thereby reducing and eliminating the possibility of color mixture or the like.

The wall portion may have a width equal to or less than a distance between adjoining ones of the photoelectric conversion elements.

More specifically, the width of the wall portion may be 0.1 μm to 0.7 μm.

Thus, the wall portion overlaps the photoelectric conversion elements, thereby reducing or preventing adverse effects on the function as the color filter layer. Moreover, the smaller the width of the wall portion is, the greater an acceptable margin for displacement of the wall portion with respect to the photoelectric conversion elements is.

It is preferable that the plurality of color filter portions have one color for each of the photoelectric conversion elements, and be arranged in a predetermined pattern of a plurality of colors according to arrangement of the plurality of photoelectric conversion elements.

For example, green, blue, and red color filter portions are arranged in a Bayer pattern to function as the color filter layer.

It is preferable that the plurality of color filter portions be formed from a photosensitive colored resin. The photosensitive colored resin is preferably a pigment dispersion resist.

The photosensitive colored resin is useful as a material of the color filter portions. In particular, the pigment dispersion resist is preferable in terms of light resistance and heat resistance. Although the pigment dispersion resist has a lower resolution than that of the dye containing resist, such a disadvantage of the pigment dispersion resist is overcome by forming the color filter portions in the openings of the wall portion.

It is preferable that the plurality of color filter portions have a refractive index higher than that of the wall portion.

Thus, light that reaches the wall portion from the color filter portions is reflected back into the color filter portions. This increases the amount of light that reaches the photoelectric conversion elements, and thus increases sensitivity as the solid state imaging device.

It is preferable that the wall portion have a light transmittance that is equal to or less than that of the color filter portions.

This enables incident light on the wall portion, not on the color filter portions, to be absorbed, reducing the amount of the incident light reaching the photoelectric conversion elements due to irregular reflection. This can reduce noise such as smear.

A method for manufacturing a solid state imaging device according to the present disclosure includes the steps of: (a) arranging a plurality of photoelectric conversion elements on a semiconductor substrate; (b) forming a wall portion above a region between the plurality of photoelectric conversion elements so that the wall portion has openings above the photoelectric conversion elements; and (c) after the step (b), forming a plurality of color filter portions, each having a predetermined color, so as to fill the openings, wherein the step (b) includes the steps of applying a first photosensitive colored resin, and exposing and developing the first photosensitive colored resin.

According to the above method, the wall portion is formed so as to protrude from the underlying surface and to have the openings above the photoelectric conversion elements, and the color filter portions are formed so as to fill the openings. Thus, if the wall portion is accurately formed in the step (b), a photomask for forming the color filter portions in the step (c) need only be patterned so as to surround the openings. That is, the accuracy requirement for the shape and alignment of the photomask is not so strict.

Note that the first photosensitive colored resin may be a dye containing resist.

As described above, since the dye containing resist has a high resolution, the dye containing resist is capable of being patterned to have satisfactory edges, and of achieving high dimensional accuracy. Thus, the dye containing resist is useful as a material of the wall portion.

In the step (b), the wall portion may be formed with a width of 0.1 μm to 0.7 μm.

In the step (c), the step of applying a second photosensitive colored resin so as to fill the plurality of openings, and exposing and developing the second photosensitive colored resin to form the color filter portions of the predetermined color only in predetermined ones of the openings may be repeated a plurality of times to form the plurality of color filter portions, which have one color for each of the photoelectric conversion elements and are arranged in a predetermined color pattern according to arrangement of the plurality of photoelectric conversion elements.

The second photosensitive colored resin may be a pigment dispersion resist.

The color filter layer having a predetermined color pattern can be formed in this manner. In particular, a pigment dispersion resist is preferably used as the second photosensitive resin in view of light resistance and heat resistance. Although the pigment dispersion resist has a low resolution, such a disadvantage of the pigment dispersion resist is overcome by forming the pigment dispersion resist so as to fill the openings of the wall portion.

It is preferable that the plurality of color filter portions have a height equal to or lower than that of the wall portion.

This can reduce or eliminate the possibility that the color filter portions may extend on an upper surface of the wall portion and cause color mixture or the like.

The method may further include the step of: (d) forming a plurality of microlenses on the plurality of color filter portions with a transparent planarizing film interposed therebetween.

A photomask, which is used to form the wall portion in the step (b), may also be used to form the plurality of microlenses in the step (d).

This enables the microlenses for increasing light collection capability to be formed without increasing the number of photomasks to be used.

It is preferable that the wall portion be formed from a negative resist, and the plurality of microlenses be formed from a positive resist.

That is, in order to form the wall portion and the microlenses with the same photomask, the negative resist is used to form the wall portion that is provided in the region between the photoelectric conversion elements, and the positive resist is used to form the microlenses that are provided above the photoelectric conversion elements.

According to the solid state imaging device and the manufacturing method thereof as described above, the possibility of color mixture, sensitivity unevenness, and the like resulting from mask misalignment can be reduced, whereby a solid state imaging device capable of providing high definition images can be implemented, and such a solid state imaging device can be manufactured with a sufficient process margin.

### BRIEF DESCRIPTION OF THE DRAWINGS

FIG. 1A is a plan view and FIGS. 1B-1C are cross-sectional views, showing an example color solid state imaging device according to an embodiment of the present disclosure.

FIG. 2A is a plan view and FIG. 2B is a cross-sectional view, illustrating a manufacturing process of the example color solid state imaging device of the embodiment.

FIG. 3 is a cross-sectional view illustrating the manufacturing process of the example color solid state imaging device after FIG. 2B.

FIG. 4A is a plan view and FIG. 4B is a cross-sectional view, illustrating the manufacturing process of the example color solid state imaging device after FIG. 3.

FIG. 5A is a plan view and FIG. 5B is a cross-sectional view, illustrating the manufacturing process of the example color solid state imaging device after FIGS. 4A-4B.

FIG. 6A is a plan view and FIG. 6B is a cross-sectional view, illustrating the manufacturing process of the example color solid state imaging device after FIGS. 5A-5B.

FIG. 7A is a plan view and FIG. 7B is a cross-sectional view, illustrating the manufacturing process of the example color solid state imaging device after FIGS. 6A and 6B.

FIGS. 8A-8B are cross-sectional views showing the relation between the height of a wall portion and the thickness of a resist that is applied to openings.

FIGS. 9A-9B are plan views illustrating a displacement of a wall portion and color mixture in the case where the wall portion has a width smaller than that of a light shielding film.

FIG. 10A is a plan view and FIG. 10B is a cross-sectional view, illustrating that no color mixture occurs in a color filter layer having such a wall portion as shown in FIG. 9B.

FIGS. 11A-11B are plan views illustrating a displacement of a wall position and color mixture in the case where the wall portion has the same width as that of a light shielding film.

FIG. 12A is a plan view and FIG. 12B is a cross-sectional view, illustrating that color mixture occurs in a color filter layer having such a wall portion as shown in FIG. 11B.

FIG. 13 is a diagram illustrating that there is no alignment margin for a photomask in the case of forming a wall portion having the same width as that of a light shielding film.

FIG. 14 is a diagram illustrating an alignment margin for a photomask in the case of forming a wall portion whose width is one half of that of a light shielding film.

FIG. 15 is a diagram illustrating that an alignment margin for a photomask increases as compared to that in FIG. 14, in the case of forming a wall portion whose width is one quarter of that of a light shielding film.

FIG. 16A is a plan view and FIG. 16B is a cross-sectional view, showing a color solid state imaging device of a related art.

FIGS. 17A-17B are plan views showing a state where circular openings are formed by green filter portions of a color filter layer of the related art, where the openings have different sizes from each other in the examples of FIGS. 17A-17B.

FIG. 18A is a plan view and FIG. 18B is a cross-sectional view, showing a color solid state imaging device having such green filter portions as shown in FIG. 17A.

FIG. 19A is a plan view and FIG. 19B is a cross-sectional view, showing a color solid state imaging device having such green filter portions as shown in FIG. 17B.

FIGS. 20A-20B are plan views illustrating examples in which the green filter portions of FIGS. 17A-17B are displaced.

FIG. 21A is a plan view and FIG. 21B is a cross-sectional view, illustrating that color mixture occurs in a color solid state imaging device having the green filter portions shown in FIG. 20A.

FIG. 22A is a plan view and FIG. 22B is a cross-sectional view, illustrating that color mixture occurs in a color solid state imaging device having the green filter portions shown in FIG. 20B.

FIG. 23 is a diagram illustrating that there is no alignment margin for a photomask if the green filter portions having the largest width are formed when manufacturing the color solid state imaging device of the related art.

FIG. 24 is a diagram illustrating that there is no alignment margin for the photomask if the green filter portions having the smallest width are formed when manufacturing the color solid state imaging device of the related art.

FIG. 25 is a diagram illustrating that an alignment margin for the photomask is obtained if the green filter portions having an intermediate width are formed when manufacturing the color solid state imaging device of the related art.

### DETAILED DESCRIPTION

An embodiment of a color solid state imaging device of the present disclosure will be described with reference to the accompanying drawings. It should be noted that the drawings schematically show the elements of the color solid state imaging device, and do not necessarily reflect actual dimensions.

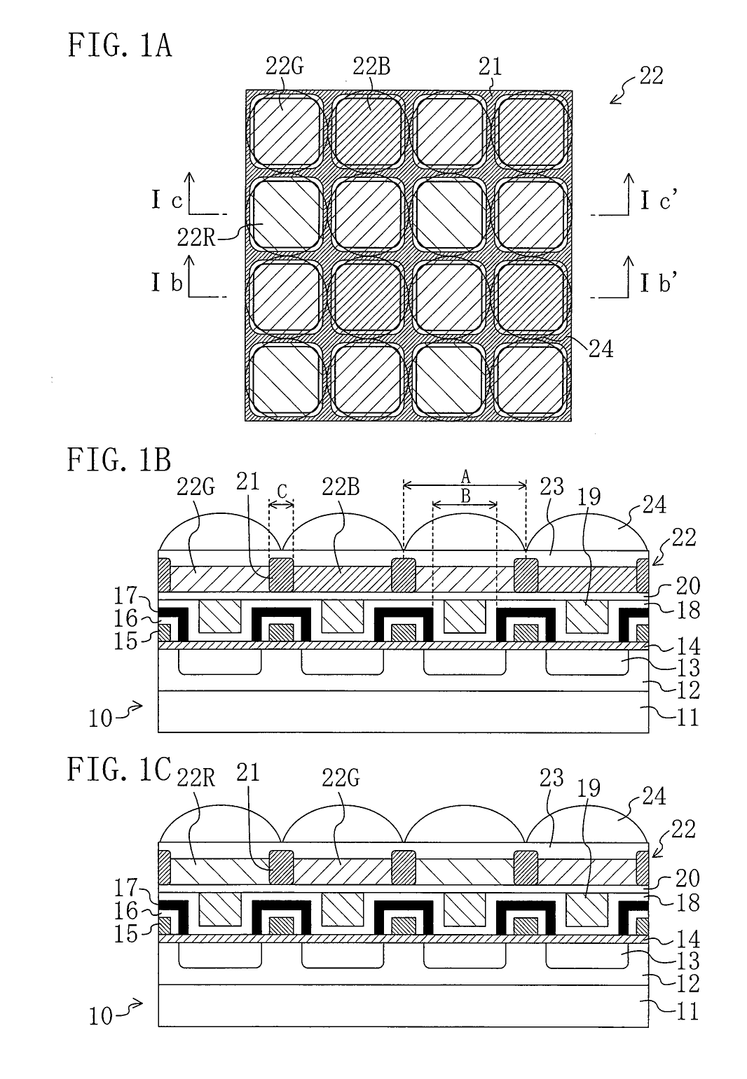

FIGS. 1A-1C are diagrams illustrating an example color solid state imaging device 10 according to the present embodiment. FIG. 1A is a plan view of a color filter layer 22 as viewed from the microlens 24 side, and FIGS. 1B-1C are cross-sectional views taken along lines Ib-Ib′ and Ic-Ic′ in FIG. 1A, respectively.

As shown in FIGS. 1B-1C, the color solid state imaging device 10 is formed by using a semiconductor substrate 11 of a first conductivity type (e.g., N-type; the first conductivity type is hereinafter simply referred to as the “N-type”).

A well layer 12 of a second conductivity type (e.g., P-type; the second conductivity type is hereinafter simply referred to as the “P-type”) is formed on the semiconductor substrate 11. A plurality of photoelectric conversion elements 13 for performing photoelectric conversion are formed as N-type semiconductor layers in the upper part of the well layer 12. The photoelectric conversion elements 13 are arranged in a matrix pattern so that each photoelectric conversion element 13 is included in a corresponding one of pixels. A gate insulating film 14 is formed so as to cover the P-type well layer 12 and the photoelectric conversion elements 13. Polysilicon transfer electrodes 15 for transferring signals are formed on the gate insulating film 14 in the regions between the photoelectric conversion elements 13.

An interlayer insulating film 16 is formed on the side surface and the upper surface of each transfer electrode 15. Thus, the interlayer insulating film 16 covers each transfer electrode 15 and insulates each transfer electrode 15 from the surrounding region. A light shielding film 17 is formed over the entire surfaces of pixel regions except over the photoelectric conversion elements 13, so as to cover the interlayer insulating film 16. The light shielding film 17 is made of tungsten or the like, and serves to block unnecessary incident light on the portions other than the photoelectric conversion elements 13.

A surface protective layer 18, which is made of SiON or the like, is formed so as to cover the gate insulating film 14 and the light shielding film 17. Since the surface protective film 18 is formed on an uneven underlying surface, the surface protective film 18 has recesses above the photoelectric conversion elements 13. A first transparent planarizing film 19 is formed so as to fill the recesses of the surface protective film 18, and the upper surface of the surface protective film 18 is made flush with the upper surfaces of the first transparent planarizing films 19. The first transparent planarizing films 19 are provided in order to accurately form a color filter layer 22 in a later step. The first transparent planarizing films 19 are formed from, e.g., a photosensitive transparent film mainly containing a phenol resin or the like. A second transparent planarizing film 20, which is made of an acrylic thermosetting transparent resin, is formed on the first transparent planarizing films 19.

The color filter layer 22 is provided on the second transparent planarizing film 20. A third transparent planarizing film 23 is formed on the color filter layer 22, and microlenses 24 are provided on the third transparent planarizing film 23 so as to be positioned above the photoelectric conversion elements 13.

The color filter layer 22 has a grid-like wall portion 21, and green filter portions 22G, blue filter portions 22B, and red filter portions 22R (hereinafter these three types of color filter portions are sometimes collectively referred to as the “color filter portions 22G, 22B, and 22R). The wall portion 21 is provided above the regions between the photoelectric conversion elements 13, and has openings above the photoelectric conversion elements 13. The color filter portions 22G, 22B, and 22R are provided so as to fill the openings. As shown in FIG. 1A, the color filter portions 22G, 22B, and 22R are arranged in a so-called Bayer pattern. That is, the color filter portions 22G, 22B, and 22R are arranged so that the rows (e.g., the row of line Ib-Ib' in FIG. 1A) and columns in which green and blue are alternately arranged, and the rows (e.g., the row of line Ic-Ic' in FIG. 1A) and columns in which red and green are alternately arranged, are alternately arranged.

The height of the wall portion 21 is greater than that of the color filter portions 22G, 22B, and 22R. This enables the color filter portions 22G, 22B, and 22R to be formed without extending over the upper edges of the openings of the wall portion 21, and thus reduces or eliminates the possibility of color mixture.

The height of the color filter portions 22G, 22B, and 22R need only be lower than that of the wall portion 21. The color filter portions 22G, 22B, and 22R can be formed with any height by changing as appropriate the thicknesses of the materials that are applied to form the color filter portions 22G, 22B, and 22R. This eases restrictions on spectral characteristics of the color filter portions 22G, 22B, and 22R, as compared to the structure in which the green filter portions 122G need to be thicker than the other color filter portions.

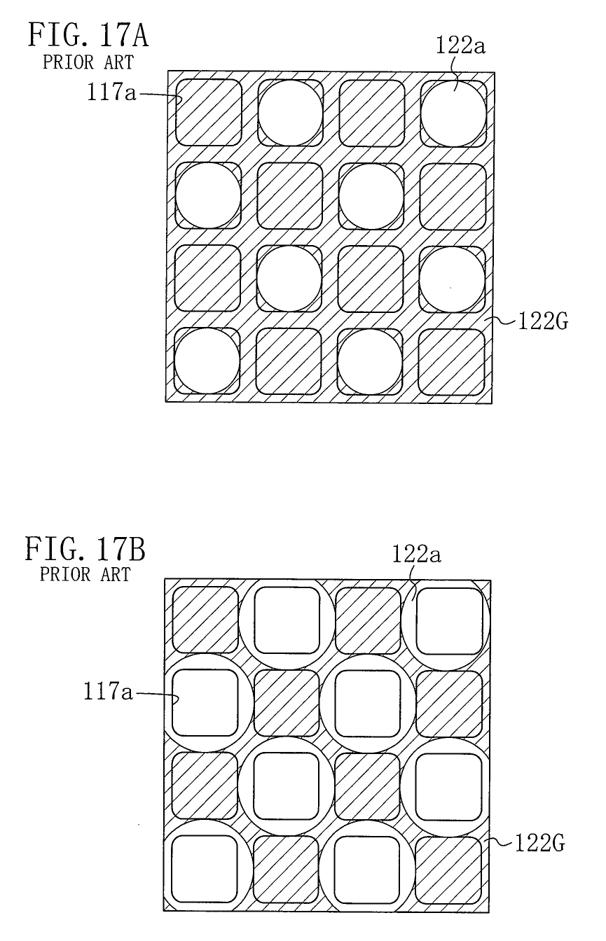

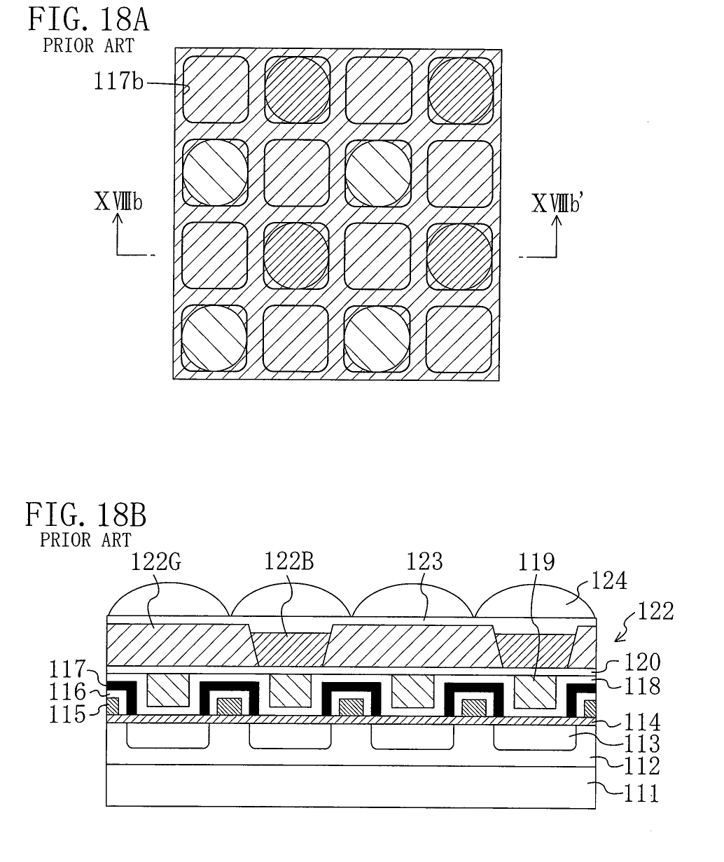

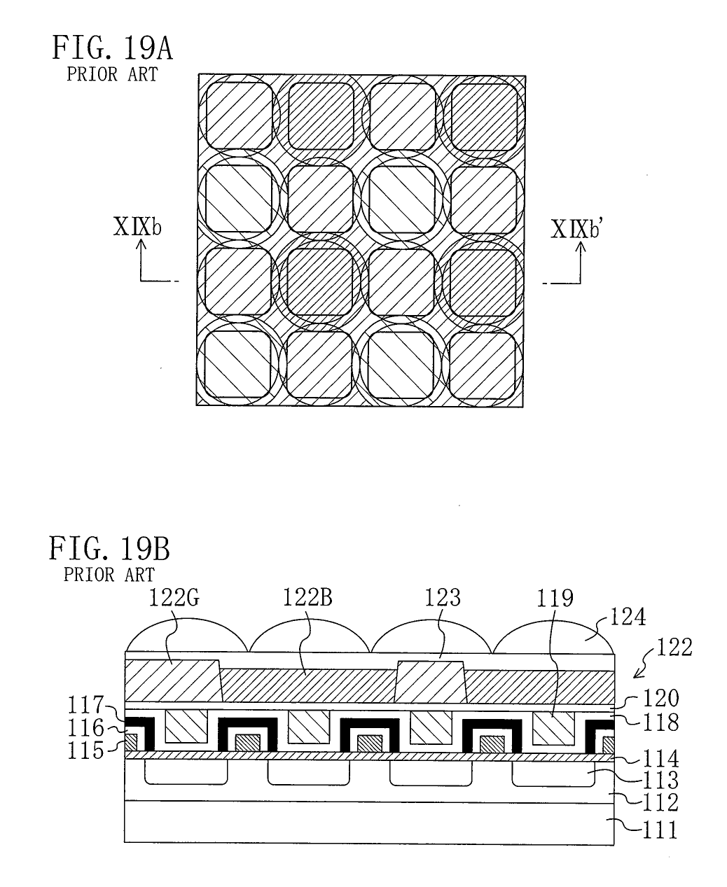

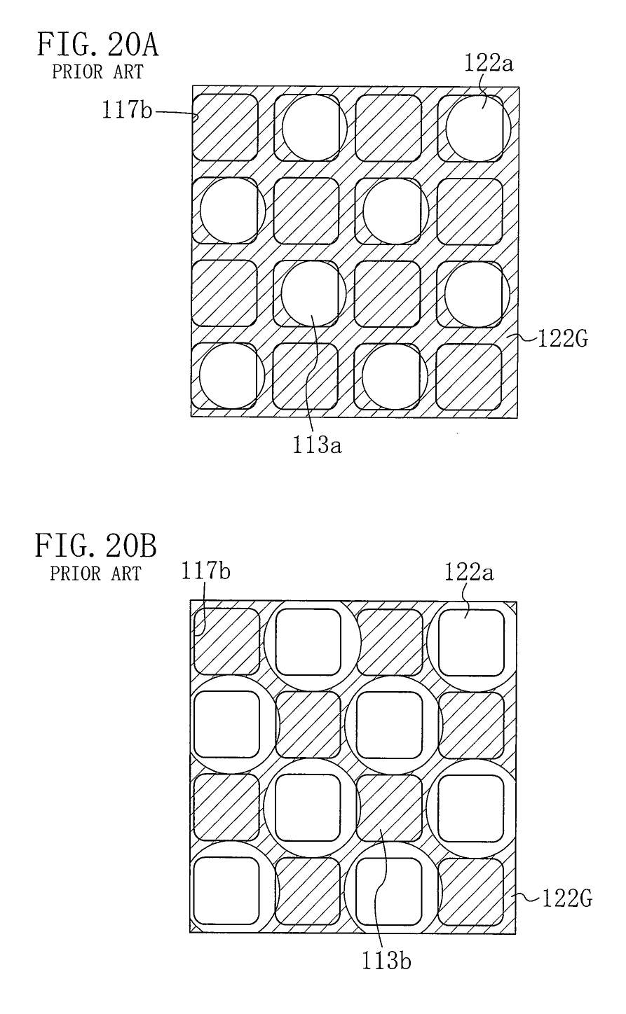

The use of a material (such as a dye containing resist) having a higher resolution than that of the pigment dispersed resists enables the wall portion 21 to be accurately formed even in a miniaturized device. For example, in the related art, the pattern becomes round as the device is minitualized, as shown in FIGS. 17A-17B. However, the use of the above material for the wall portion 21 facilitates formation of a pattern having a shape close to a quadrilateral. The edges of the pattern extend obliquely in cross section if the pigment dispersion resist is used. However, the use of the above material enables the edges of the pattern to extend perpendicularly rather than obliquely in cross section.

The color filter portions 22G, 22B, and 22R are formed so as to fill the openings of the wall portion 21. Thus, although pigment dispersion resists have a lower resolution than the above material, forming the color filter portions 22G, 22B, and 22R from the pigment dispersion resist does not affect the accuracy, and the advantages of the pigment dispersion resist (high light resistance and high heat resistance) can be effectively used.

In this manner, the color filter portions 22G, 22B, and 22R can be formed with a uniform shape, and the possibility that adjoining ones of the color filter portions may overlap each other can be reduced or eliminated. Thus, optical characteristics, such as color mixture from adjoining color filter portions, sensitivity unevenness, gray levels of lines, and color shading, can be improved.

The refractive index of the color filter portions 22G, 22B, and 22R can be higher than that of the wall portion 21. In this case, light, which reaches the wall portion 21 from the color filter portions, is reflected toward the color filter portions, and thus is efficiently collected by the photoelectric conversion elements 13. This can increase light sensitivity of the color solid state imaging device 10.

The light transmittance of the wall portion 21 can be lower than that of the color filter portions 22G, 22B, and 22R. This enables incident light on the wall portion 21 to be absorbed, reducing the amount of the incident light reaching the photoelectric conversion elements 13 due to irregular reflection. This can reduce noise such as smear.

Examples of the dimensions of the color solid state imaging device 10 will be described. As shown in FIG. 1B, the pixels have a width A of about 1.4 μm, and the opening between the light shielding films 17 in each pixel has a width B of about 0.7 to 0.8 μm, and the wall portion 21 between the pixels has a width C of about 0.3 to 0.4 μm. These dimensions are exemplary only, and the color solid state imaging device 10 can be designed to have any dimensions. However, it is preferable that the pixel width A be about 1.6 μm or less, and the width C of the wall portion 21 be about 0.1 to 0.7 μm. The problems of the related art become significant when the color solid state imaging device has such dimensions or smaller dimensions. Thus, the color solid state imaging device 10 of the present embodiment, which solves the problems of the related art, is especially useful in the case where the color solid state imaging device 10 have the above dimensions or smaller dimensions.

A manufacturing method of the color solid state imaging device 10, especially a manufacturing method of the color filter layer 22, will be described with reference to the figures.

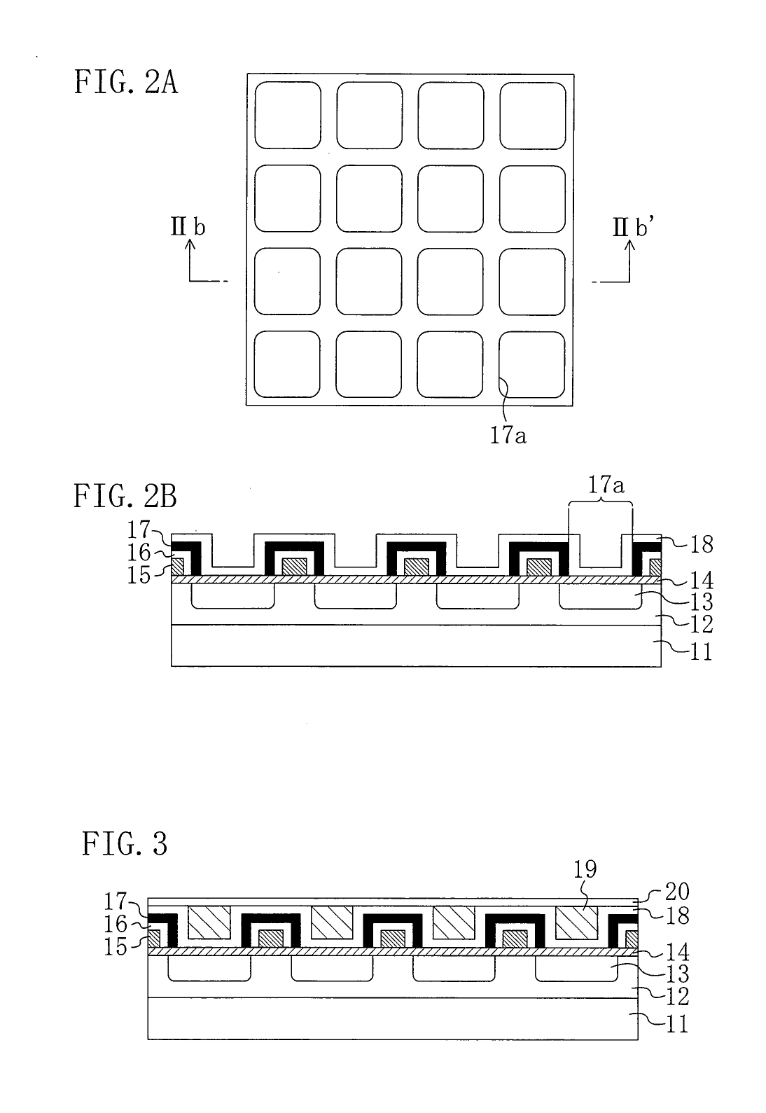

FIG. 2A is a plan view showing the color solid state imaging device 10 during the manufacturing process, and FIG. 2B is a cross-sectional view taken along line IIb-IIb′ in FIG. 1A.

First, a P-type well layer 12 is formed on an N-type semiconductor substrate 11, and photoelectric conversion elements 13 are formed as N-type impurity diffusion layers in the surface of the well layer 12 so as to be arranged in a matrix shape when viewed in plan. The well layer 12 and the photoelectric conversion elements 13 are formed by a commonly used method, namely by repeating a photolithography process, an ion implantation process, and a thermal diffusion process.

Then, a gate insulating film 14 is formed so as to cover the well layer 12 and the photoelectric conversion elements 13. Subsequently, polysilicon transfer electrodes 15 are formed on the gate insulating film 14. The transfer electrodes 15 are formed in the regions between the photoelectric conversion elements 13. An interlayer insulating film 16 and a light shielding film 17 are sequentially formed. The interlayer insulating film 16 covers the surfaces of the transfer electrodes 15 to electrically insulate the transfer electrodes 15. The light shielding film 17 is made of tungsten or the like, and covers the interlayer insulating film 16.

After the light shielding film 17 is formed, a surface protective film 18 is formed by a heat flow process or the like so as to cover the surfaces of the gate insulating film 14 and the light shielding film 17. The surface protective film 18 is made of, e.g., a boron phosphosilicate glass (BPSG) film, a SiON film, or the like. At this time, the upper surface of the surface protective film 18 has recesses (concave portions) above the photoelectric conversion elements 13, namely between the transfer electrodes 15. Note that, in FIGS. 2A and 2B, the regions where no light shielding film 17 is formed are shown as opening regions 17a. Light that is incident on the opening regions 17a reaches the photoelectric conversion elements 13, and is detected by the photoelectric conversion elements 13.

Then, interconnects are formed from an aluminum alloy or the like, and a SiON film, for example, is deposited to protect the interconnects. Bonding pads for extending electrodes are formed. The interconnects, the SiON film, and the bonding pads are not shown in the figures.

The step of FIG. 3 will be described below. First, a first transparent planarizing film 19 is formed as a pretreatment in order to accurately form a color filter layer 22. The first transparent planarizing film 19 is formed so as to fill the recesses formed between protrusions such as the aluminum alloy interconnect regions, the polysilicon transfer electrodes 15, and the like. For example, the first transparent planarizing film 19 can be formed by applying a photosensitive transparent resist mainly containing a phenol resin, and performing exposure and development (including bleaching and baking) by using a predetermined photomask. Alternatively, the first transparent planarizing film 19 may be formed by applying a transparent film a plurality of times and planarizing the transparent film by an etch back process, by applying a transparent film and planarizing the transparent film by a heat flow process, or the like. Combinations of these methods may be used to further increase the flatness.

In this manner, the first transparent planarizing film 19 can be formed which fills the recesses above the photoelectric conversion elements 13 and has an increased light transmittance by ultraviolet (UV) radiation.

Then, an acrylic thermosetting transparent resin, for example, is applied to the surface protective film 18 and the first transparent planarizing film 19, and is cured by a heat treatment to form a second transparent planarizing film 20. The second transparent planarizing film 20 is formed in order to increase adhesion between the wall portion 21 and color filter portions 22G, 22B, and 22R, and to reduce the amount of development residue, when forming a color filter layer 22.

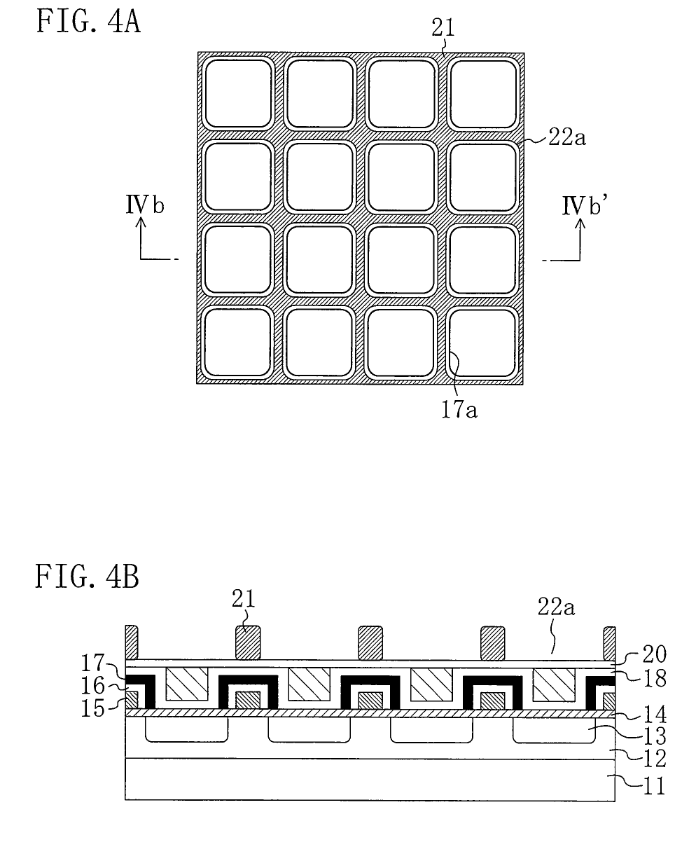

The step shown in FIGS. 4A-4B will be described below. FIG. 4A is a plan view, and FIG. 4B is a cross-sectional view taken along line IVb-IVb′ in FIG. 4A. In this step, a wall portion 21 is formed on the second transparent planarizing film 20.

The wall portion 21 is formed in the regions corresponding to the boundaries of the color filter portions 22G, 22B, and 22R that are to be formed in a later step. In other words, the wall portion 21 is formed in non-light-receiving regions located between adjoining ones of the photoelectric conversion elements 13, namely in regions above the transfer electrodes 15 and the light-shielding film 17. As shown in FIG. 4A as well, the wall portion 21 has a grid-shaped pattern as viewed in plan. The wall portion 21 protrudes from the second transparent planarizing film 20, and has openings 22a above the photoelectric conversion elements 13.

The wall portion 21 is formed by applying a photosensitive negative dye containing resist, and exposing and developing the dye containing resist by using a predetermined photomask. It is preferable that the width of the wall portion 21 be smaller than that of the light shielding film 17. By using a dye containing resist having a higher resolution than that of the pigment dispersion resists, the wall portion 21 can be formed with high accuracy even in the miniaturized color filter layer 22. Although a green dye containing resist is used in this example, other colors such as black may be used. However, the color should be able to be used as the resist.

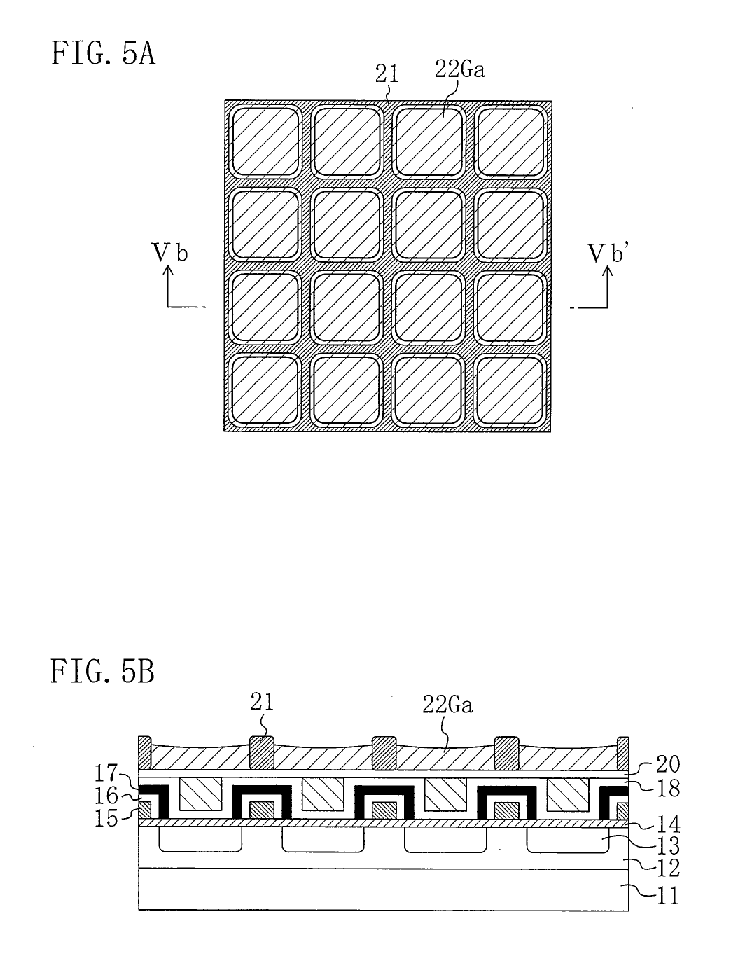

The step shown in FIGS. 5A-5B will be described below. FIG. 5A is a plan view, and FIG. 5B is a cross-sectional view taken along line Vb-Vb′ in FIG. 5A.

After the wall portion 21 having a grid-shaped pattern is formed, a hexamethyldisilazane (HMDS) film is vapor deposited, and a green pigment dispersion resist 22Ga for forming the green filter portions 22G, for example, is applied. The green filter portions 22G are formed under such conditions that no green filter portion 22G will remain on the grid-shaped wall portion 21, namely under such conditions that the thickness of the green filter portions 22G is the same as, or smaller than that of the wall portion 21.

Note that the green pigment dispersion resist used in this example contains a pigment that is prepared so as to selectively transmit green light therethrough. Deposition of the HMDS film may be omitted if adhesion of the green pigment dispersion resist to the second transparent planarizing film 20 is strong enough.

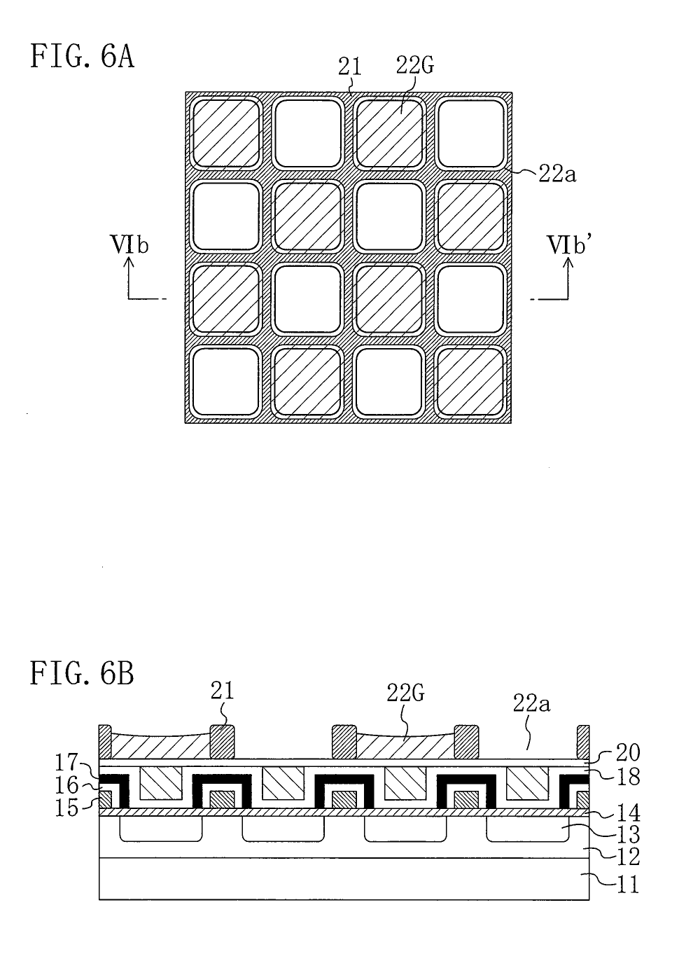

The step shown FIGS. 6A-6B will be described below. FIG. 6A is a plan view, and FIG. 6B is a cross-sectional view taken along line VIb-VIb′ in FIG. 6A.

The negative green pigment dispersion resist 22Ga applied as described above is exposed and developed by using a predetermined photomask. The photomask is designed to have a checkered pattern so that every other green filter portion 22G is left in each row and each column above the photoelectric conversion elements 13.

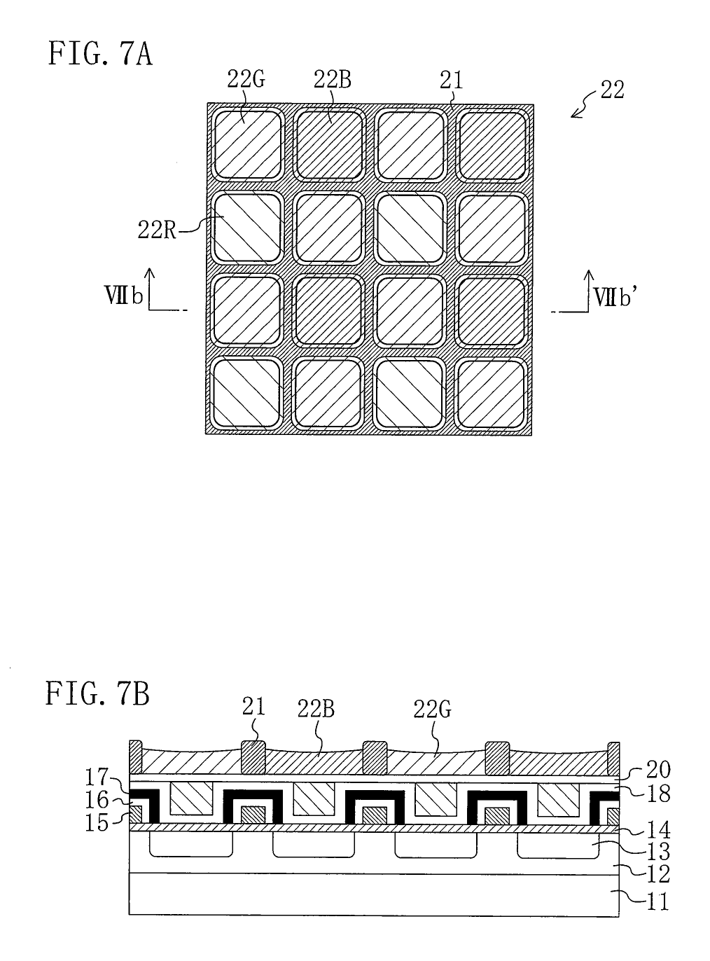

The step shown FIGS. 7A-7B will be described below. FIG. 7A is a plan view, and FIG. 7B is a cross-sectional view taken along line VIIb-VIIb′ in FIG. 7A.

After the color filter portions of a first color (the green filter portions 22G) are formed, color filter portions of a second color (e.g., blue filter portions 22B) and color filter portions of a third color (e.g., red filter portions 22R) are formed sequentially. These color filter portions are formed by a method similar to that of the green filter portions 22G described above. That is, these color filter portions are formed by applying a negative pigment dispersion resist of a corresponding color, and exposing and developing the negative pigment dispersion resist by using a photomask. The photomask is designed so that the color filter portions are formed at predetermined positions.

Then, a third transparent planarizing film 23 is formed on the color filter layer 22, and microlenses 24 are formed on the third transparent planarizing film 23. The color solid state imaging device 10 shown in FIGS. 1A-1C is completed in this manner.

Note that, for example, the step of applying a thermosetting transparent resin mainly containing an acrylic resin, to the entire surface, and curing the thermosetting transparent resin by a baking process (a heat treatment) with a hot plate is repeated several times to form the third transparent planarizing film 23. Then, the third transparent planarizing film 23 is etched as much as possible by a known etch-back method. This etching process is performed in order to increase sensitivity by reducing the distance from the light receiving surface to the upper surface of the third transparent planarizing film 23, and to increase flatness of the upper surface of the third transparent planarizing film 23. This etching process may be performed also on the wall portion 21 so that the wall portion 21 has a uniform height corresponding to the highest position of the color filter portions 22G, 22B, and 22R.

Then, microlenses 24, which are convex upward, are formed on the surface of the third transparent planarizing film 23. The microlenses 24 are positioned above the photoelectric conversion elements 13. The microlenses 24 are formed by the step of applying a photosensitive positive transparent resist mainly containing a phenol resin, to the third transparent planarizing film 23, and performing exposure and development processes (including bleaching and baking processes) by using a predetermined photomask. The microlenses 24 have an increased light transmittance by UV radiation (bleaching).

Note that it is desirable that the microlenses 24 be baked at a relatively low temperature, e.g., 200° C. or less, in order to reduce or eliminate the possibility of degradation in spectral characteristics of the color filter portions 22G, 22B, and 22R and the wall portion 21.

The microlenses 24 may be formed by using the same photomask as that used to form the wall portion 21. This can be implemented by forming the wall portion 21 by using a negative resist, and forming the microlenses 24 by using a positive resist. When the development process is finished, the resist, which is a material of the microlenses 24, has a shape similar to that of the openings 22a of FIG. 4A as viewed in plan. The circular microlenses 24 are formed by the subsequent baking process.

The color solid state imaging device 10 of the present embodiment is manufactured by the above process. As described above, the wall portion 21 is accurately formed by using a dye containing resist having a high resolution, and the color filter portions 22G, 22B, and 22R are formed by pigment dispersion resists so as to fill the openings of the wall portion 21. This enables the color filter layer 22 having neither gaps nor overlaps to be formed. As a result, a color solid state imaging device capable of providing high definition images can be manufactured.

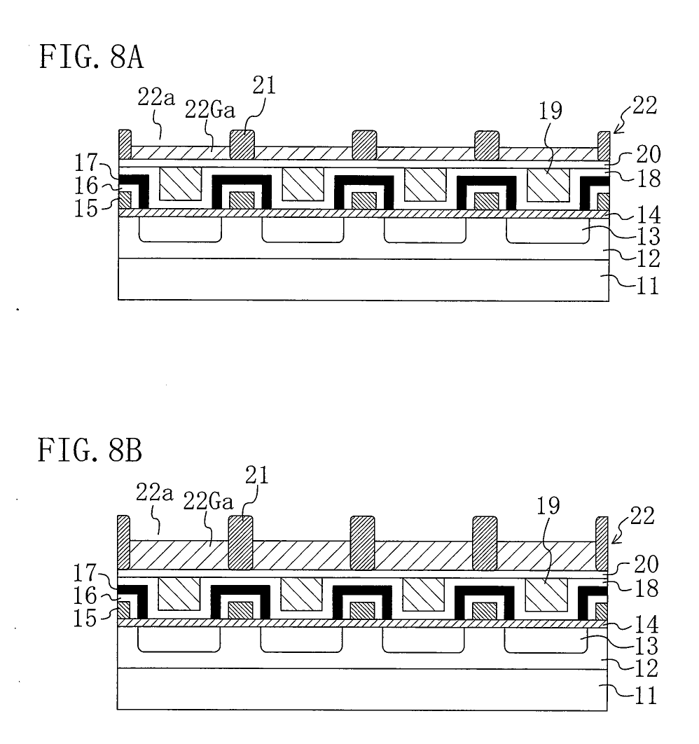

Note that FIGS. 8A-8B show the relation between the thickness (the height) of the wall portion 21 and the thickness of the green pigment dispersion resist 22Ga applied so as to fill the openings 22a. More specifically, the step of FIG. 5B (the step of applying the pigment dispersion resist to the substrate having the wall portion formed thereon) is performed with various thicknesses of the wall portion 21 under such conditions that the pigment dispersion resist is applied with a thickness of 0.3 μm if applied to a flat surface. FIGS. 8A-8B show that the thickness of the pigment dispersion resist varies according to the thickness of the wall portion 21. FIG. 8A shows an example in which the wall portion 21 has a thickness of 0.3 μm. In this case, the pigment dispersion resist has a thickness of 0.15 μm. FIG. 8B shows an example in which the wall portion 21 has a thickness of 0.45 μm. In this case, the pigment dispersion resist has a thickness of 0.3 μm. In these examples the green filter portions 22G having different thicknesses are obtained by performing the subsequent manufacturing processes. The same applies to the color filter portions of the other colors.

Thus, one method to control the thicknesses of the color filter portions 22G, 22B, and 22R is to use the difference in thickness of the wall portion 21. This method is useful in controlling characteristics of the color filter layer 22.

Although not shown in the figure, the smaller the pitch of the wall portion 21 is, the closer the thickness of the resist applied to the openings 22a is to the thickness of the wall portion 21.

The relation among the width of the wall portion 21, the position of the wall portion 21 with respect to the light shielding film 17 (alignment of the photomask for foaming the wall portion 21), and color mixture will be described below.

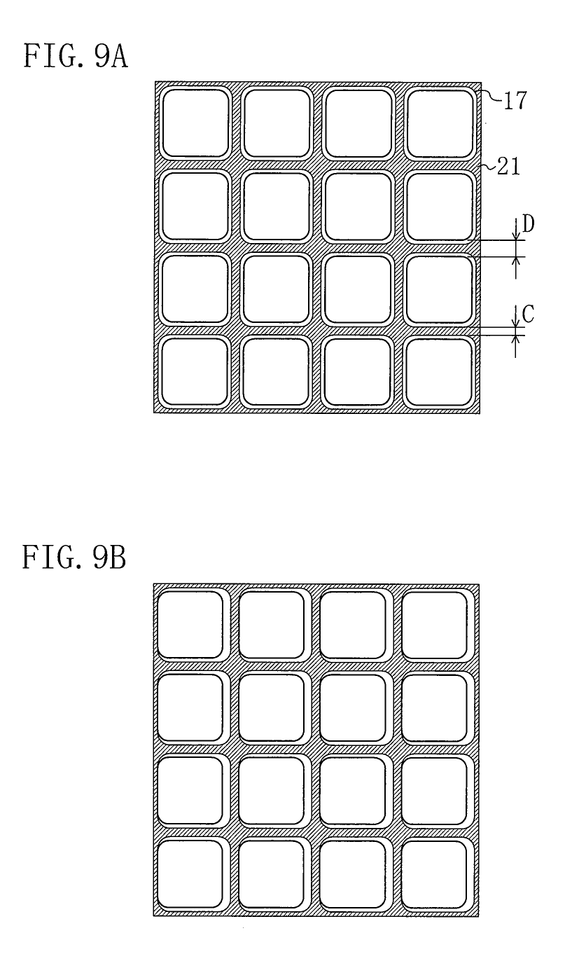

FIGS. 9A-9B show examples in which the width C of the wall portion 21 is smaller than the width D of the light shielding film 17 that covers the transfer electrodes 15. More specifically, FIG. 9A shows an example in which the wall portion 21 is formed without displacement, and FIG. 9B shows an example in which the wall portion 21 is displaced to the right. As shown in the figures, in the case where the width C is smaller than the width D, no color mixture or the like occurs if the amount of displacement of the wall portion 21 is small. That is, there is a predetermined alignment margin for the wall portion 21.

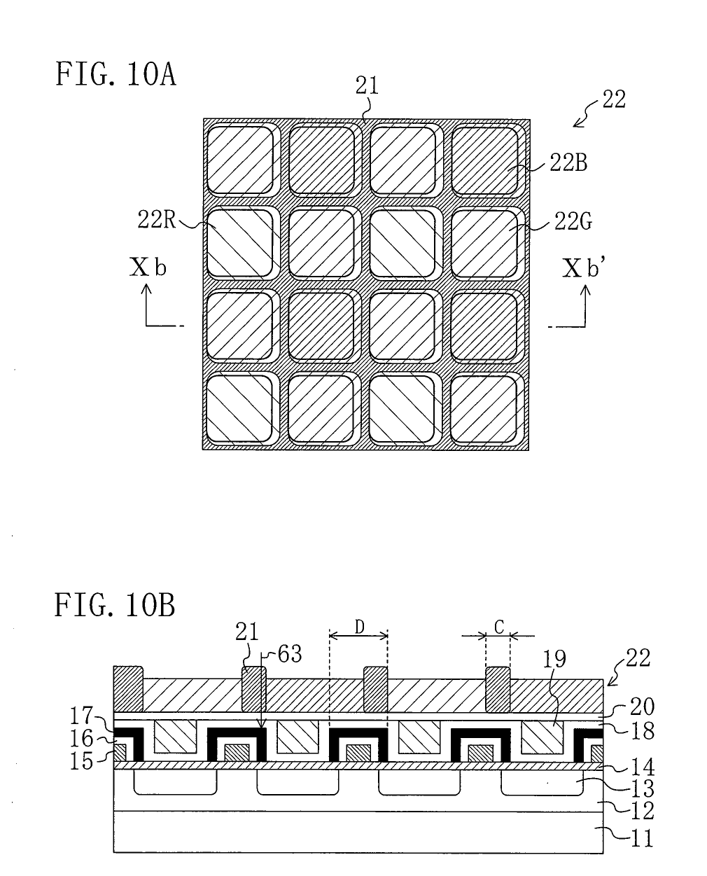

FIGS. 10A-10B show the case where the color filter layer 22 is formed with the wall portion 21 located at the position of FIG. 9B. FIG. 10A is a plan view, and FIG. 10B is a cross-sectional view taken along line Xb-Xb′ in FIG. 10A. As shown in the figures, when the width C of the wall portion 21 is smaller than the width D of the light shielding film 17, light 63 incident on the wall portion 21 is blocked by the light shielding film 17, and does not reach the photoelectric conversion elements 13, even if the wall portion 21 is slightly displaced. That is, no color mixture occurs in this case.

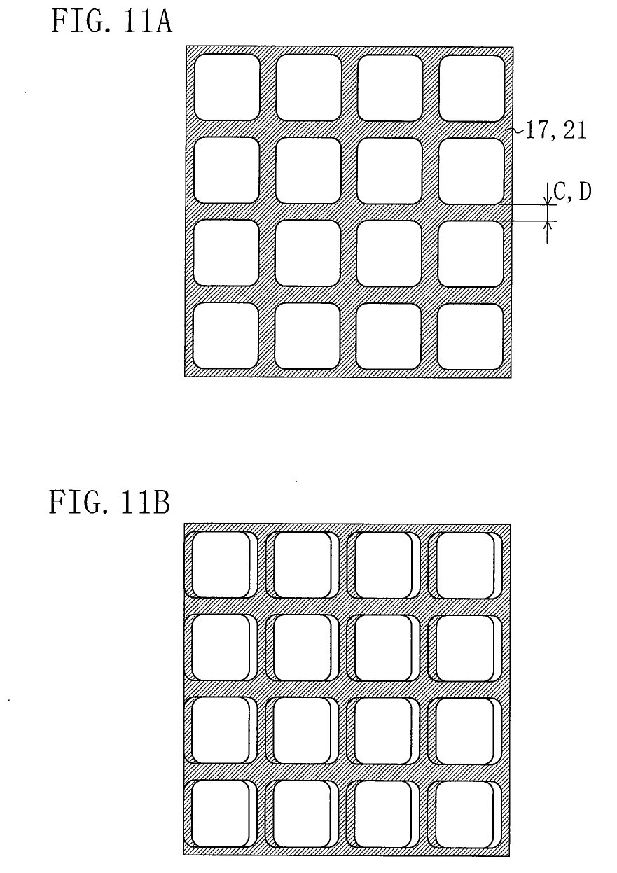

FIGS. 11A-11B show the case where the width D of the light shielding film 17 is the same as the width C of the wall portion 21. If the width C of the wall portion 21 is larger than this, the wall portion 21 overlaps the photoelectric conversion elements 13 even if the wall portion 21 is not displaced. Thus, the width C in this example is the largest possible width. In this case as well, no color mixture occurs unless the wall portion 21 is displaced (FIG. 11A). However, even a slight displacement of the wall portion 21 results in color mixture (FIG. 11B).

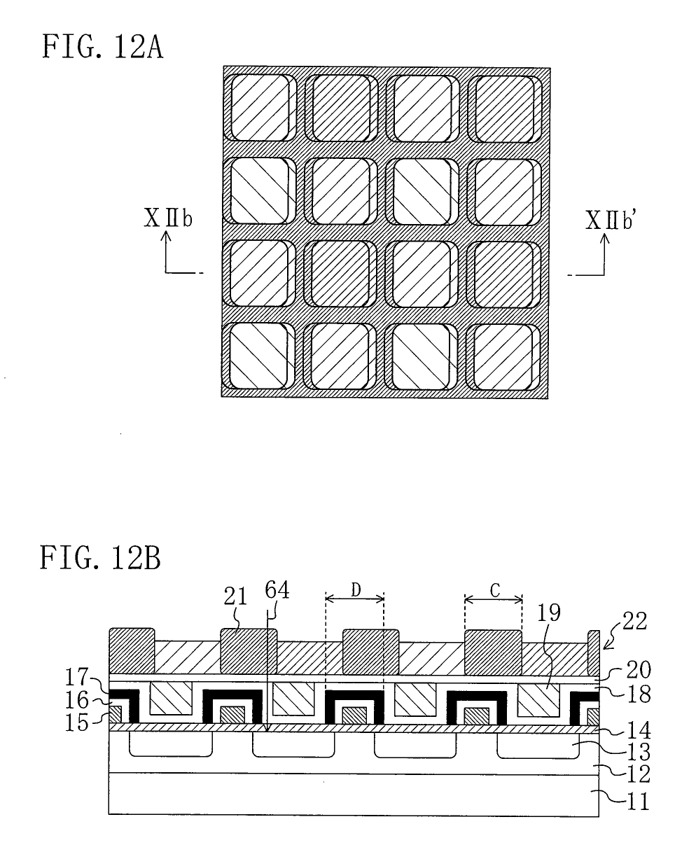

FIGS. 12A-12B show the case where the color filter layer 22 is formed with the wall portion 21 located at the position of FIG. 11B. FIG. 12A is a plan view, and FIG. 12B is a cross-sectional view taken along line XIIb-XIIb′ in FIG. 12A. As shown in the figures, if the width D of the light shielding film 17 is the same as the width C of the wall portion 12, even a slight displacement of the wall portion 21 can cause light 64, incident on the wall portion 21, to reach the photoelectric conversion elements 13. That is, even a slight displacement of the wall portion 21 can result in color mixture.

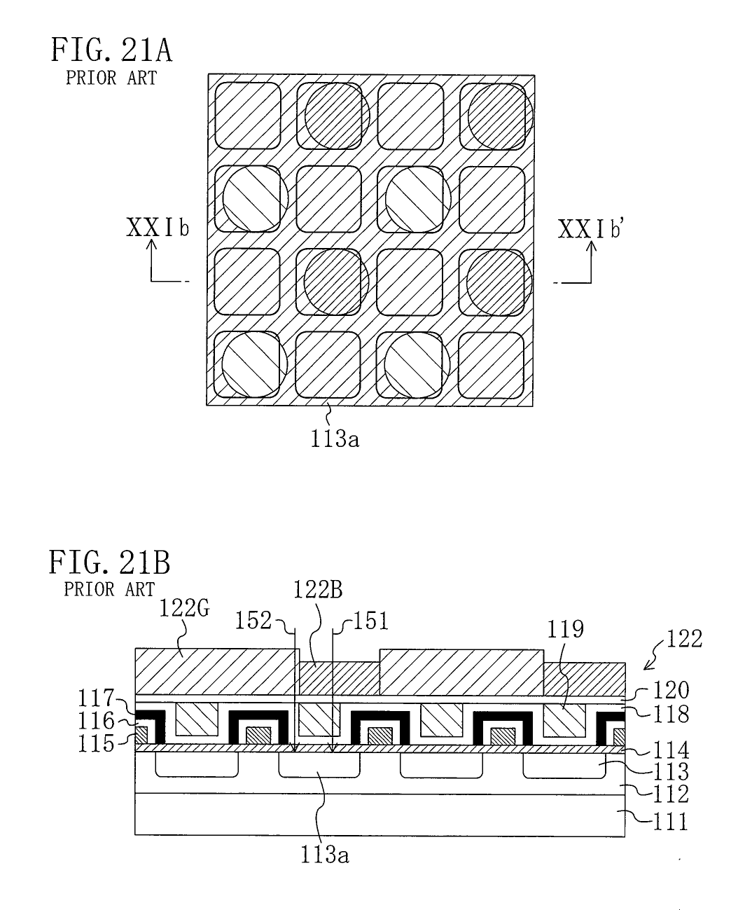

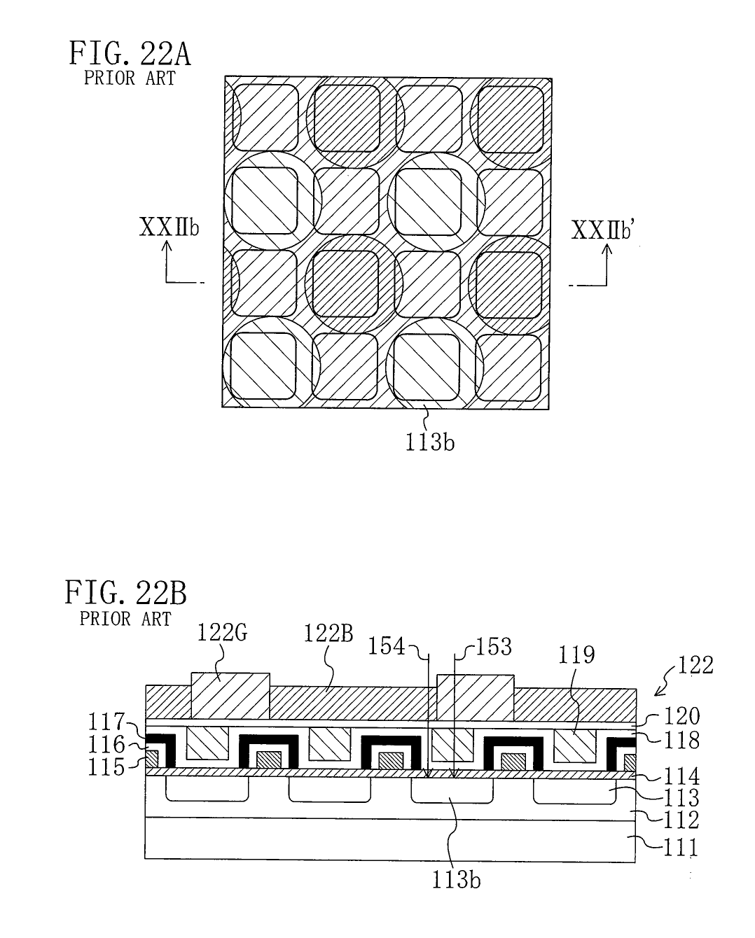

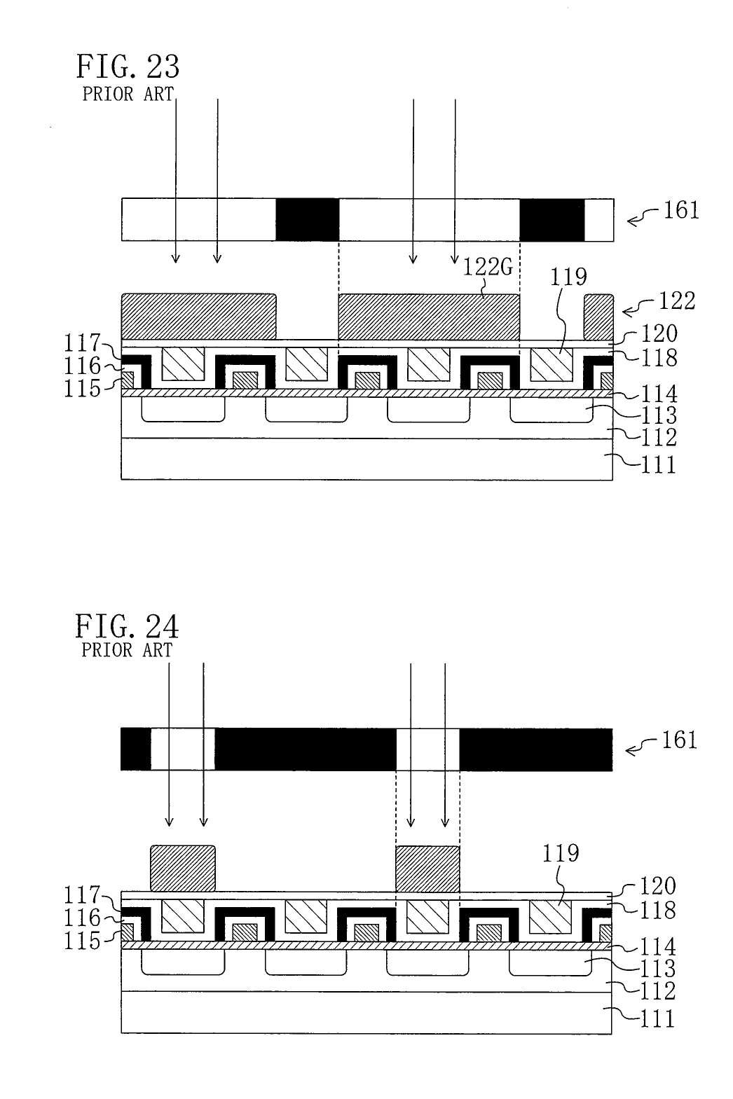

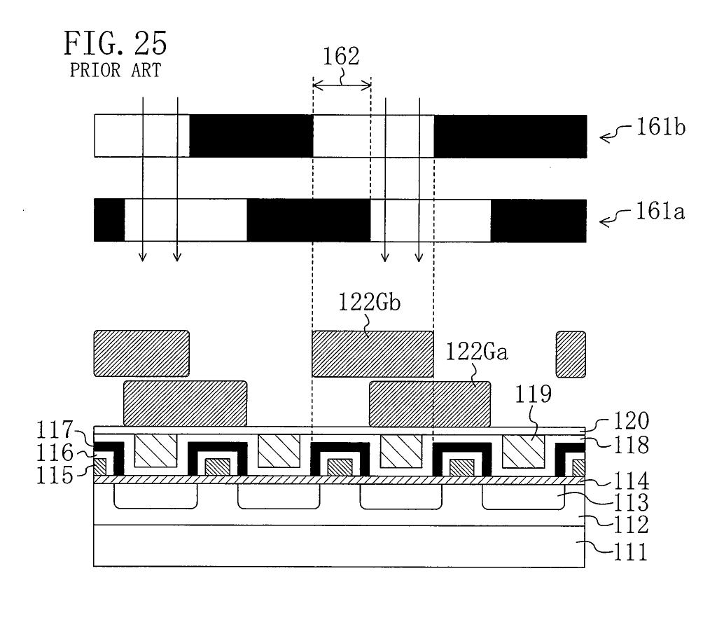

It should be noted that color mixture in color solid state imaging devices of the related art is a phenomenon in which light that has passed through the color filter portions of other colors mixes with light that has passed through the color filter portions of a predetermined color (see FIGS. 21B, 22B and the like). On the other hand, in the color solid state imaging device of the present embodiment, color mixture shown in FIG. 12B is caused when light that has passed through the wall portion 21 mixes with light that has passed through the color filter portions of a predetermined color. Since the light transmittance of the wall portion 21 is lower than that of the color filter portions 22G, 22B, and 22R, only a small amount of light passes through the wall portion 21. Thus, even if color mixture occurs, such color mixture hardly affects image quality.

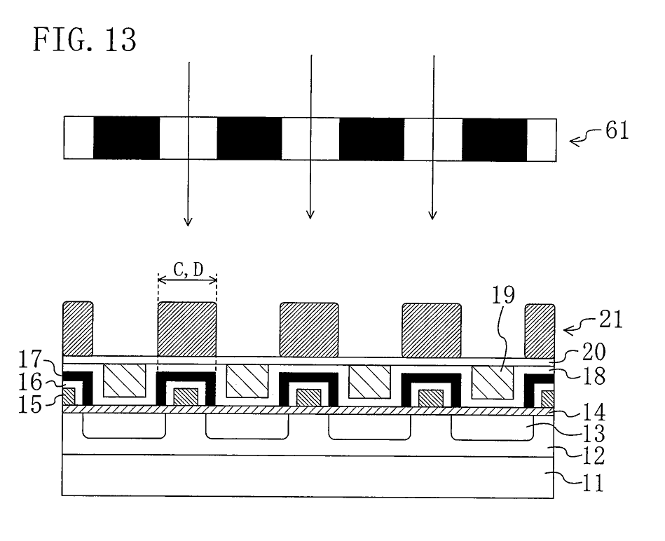

FIGS. 13-15 show various widths of the wall portion 21 and corresponding alignment margins for the photomask for forming the wall portion 21.

FIG. 13 shows an example in which the width C of the wall portion 21 is the same as the width D of the light shielding film 17. In this case, even a slight misalignment of the photomask 61 displaces the wall portion 21 away from the position above the light shielding film 17, thereby resulting in color mixture. That is, the photomask 21 has no alignment margin.

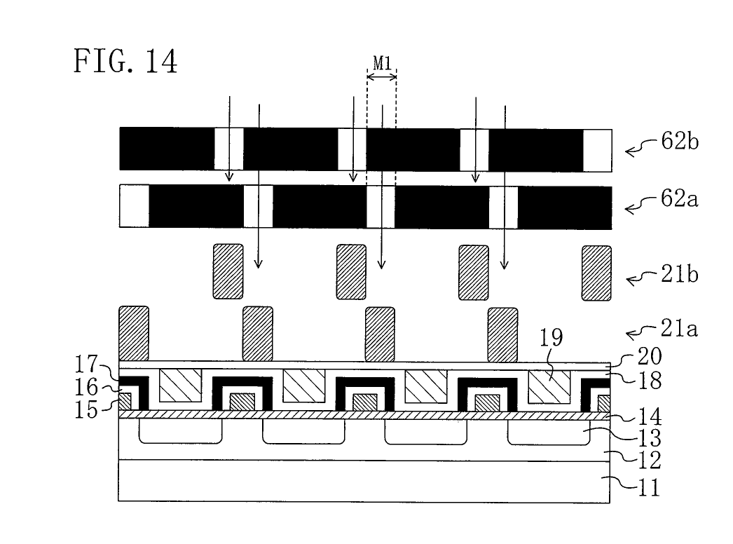

FIG. 14 shows an example in which the width C of the wall portion 21 is one half (½) of the width D of the light shielding film 17. In this case, no color mixture occurs if a misalignment of the photomask 21 is within the range from the rightmost position (the position of a photomask 62a and a wall portion 21a) to the leftmost position (the position of a photomask 62b and a wall portion 21b) in the figure. That is, an alignment margin M1 can be obtained.

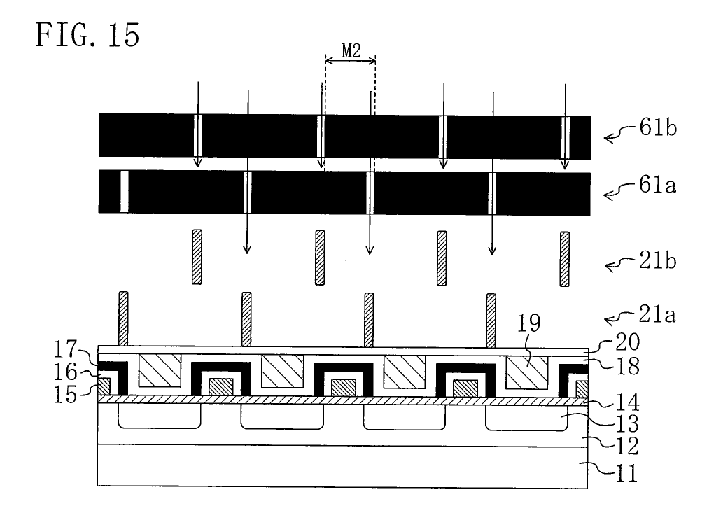

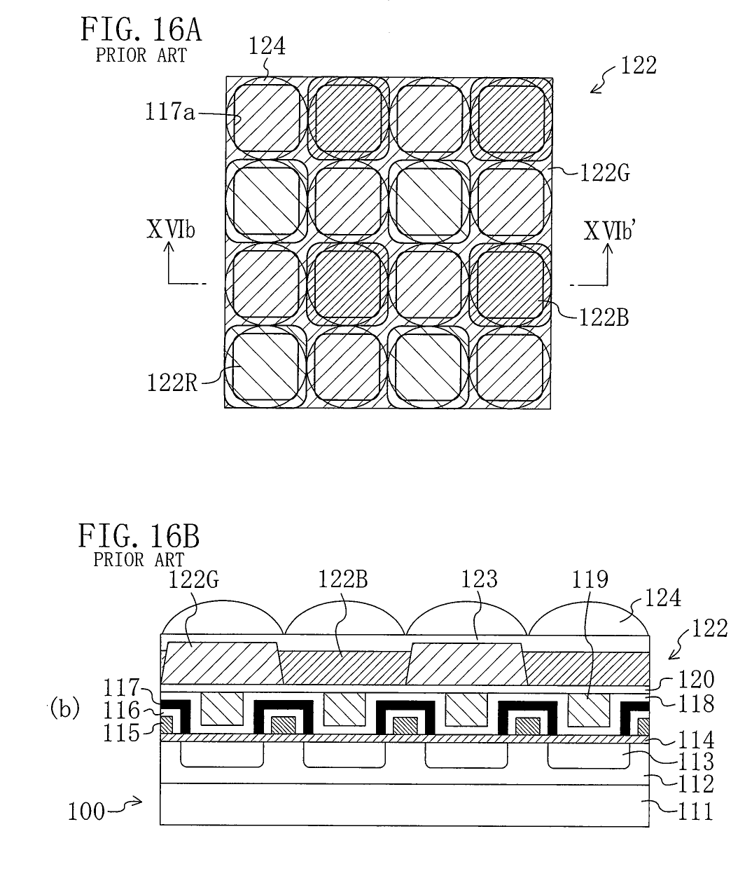

FIG. 15 shows the case where the width C of the wall portion 21 is smaller than one half (½) of the width D of the light shielding film 17 (e.g., the case where the width C of the wall portion 21 is one quarter (¼) of the width D of the light shielding film 17). In this case as well, an alignment margin M2 can be obtained as in the case of FIG. 14. The alignment margin M2 is larger than the alignment margin M1 of FIG. 14.

Thus, the mask alignment margin can be increased by reducing the width of the wall portion 21. Accordingly, it is preferable that the wall portion 21 be formed with the smallest possible width C. The lower limit of the width C is determined by the minimum possible dimensions that can be implemented as a pattern, the minimum possible dimensions that can be formed, and the like.

Note that the alignment margin for forming the wall portion 21 is larger than that for forming the green filter portions 122G in the related art. The reason for this is as follows. The green filter portions 122G is made of a pigment dispersion resist. As the device is miniaturized, the resolution of the pigment dispersion resist becomes insufficient, and round openings are formed in the green filter portions 122G. On the other hand, since the wall portion 21 is made of a dye containing resist, the openings 22a having a shape closer to a quadrilateral can be more easily obtained.

Although the color solid state imaging device 10 and the manufacturing method thereof according to the embodiment are described above, the present disclosure is not limited to the above embodiment. The present disclosure can be implemented in various forms without departing from the scope of the present disclosure. For example, a primary color type color filter layer, which is used in such solid state imaging devices that hue is more important than sensitivity, is described above as an example of the color filter layer 22. However, a complementary color type color filter layer, which is used in such solid state imaging devices that sensitivity is more important than hue, may be used as the color filter layer 22. In the case of the complementary color type color filter layer, magenta light color filter portions, green light color filter portions, yellow light color filter portions, and cyan light color filter portions are arranged at predetermined positions according to a known color pattern.

Although a charge coupled device (CCD)-type solid state imaging device is described in the above embodiment, the present disclosure is not limited to this. The technique described above may be applied to amplifying solid state imaging devices such as a metal oxide semiconductor (MOS) type solid state imaging device, and to other types of solid state imaging devices.

The solid state imaging device and the manufacturing method as described above are useful for color solid state imaging devices having superior optical characteristics, such as color mixture from adjoining pixels, gray levels of lines, color shading, and sensitivity unevenness, due to the structure of a color filter layer.

What is claimed is:

1. A solid state imaging device, comprising:
a plurality of photoelectric conversion elements arranged in a matrix pattern on a semiconductor substrate;
a wall portion provided above a region between the plurality of photoelectric conversion elements; and
a plurality of color filter portions provided above the photoelectric conversion elements so as to fill openings surrounded by the wall portion, wherein
the wall portion is formed from a dye containing resist.

2. The solid state imaging device of claim 1, wherein
the plurality of color filter portions have a height equal to or less than that of the wall portion.

3. The solid state imaging device of claim 1, wherein
the wall portion has a width equal to or less than a distance between adjoining ones of the photoelectric conversion elements.

4. The solid state imaging device of claim 3, wherein
the width of the wall portion is 0.1 μm to 0.7 μm.

5. The solid state imaging device of claim 1, wherein
the plurality of color filter portions have one color for each of the photoelectric conversion elements, and are arranged in a predetermined pattern of a plurality of colors according to arrangement of the plurality of photoelectric conversion elements.

6. The solid state imaging device of claim 1, wherein
the plurality of color filter portions are formed from a photosensitive colored resin.

7. The solid state imaging device of claim 6, wherein
the photosensitive colored resin is a pigment dispersion resist.

8. The solid state imaging device of claim 1, wherein
the plurality of color filter portions have a refractive index higher than that of the wall portion.

9. The solid state imaging device of claim 1, wherein
the wall portion has a light transmittance that is equal to or less than that of the color filter portions.

10. A method for manufacturing a solid state imaging device, comprising the steps of:
(a) arranging a plurality of photoelectric conversion elements on a semiconductor substrate;
(b) forming a wall portion above a region between the plurality of photoelectric conversion elements so that the wall portion has openings above the photoelectric conversion elements; and
(c) after the step (b), forming a plurality of color filter portions, each having a predetermined color, so as to fill the openings, wherein
the step (b) includes the steps of
applying a first photosensitive colored resin, and
exposing and developing the first photosensitive colored resin.

11. The method of claim 10, wherein
the first photosensitive colored resin is a dye containing resist.

12. The method of claim 11, wherein
in the step (b), the wall portion is formed with a width of 0.1 μm to 0.7 μm.

13. The method of claim 10, wherein
in the step (c), the step of applying a second photosensitive colored resin so as to fill the plurality of openings, and exposing and developing the second photosensitive colored resin to form the color filter portions of the predetermined color only in predetermined ones of the openings is repeated a plurality of times to form the plurality of color filter portions, which have one color for each of the photoelectric conversion elements and are arranged in a predetermined color pattern according to arrangement of the plurality of photoelectric conversion elements.

14. The method of claim 13, wherein
the second photosensitive colored resin is a pigment dispersion resist.

15. The method of claim 10, wherein
the plurality of color filter portions have a height equal to or lower than that of the wall portion.

16. The method of claim 10, further comprising the step of:
(d) forming a plurality of microlenses on the plurality of color filter portions with a transparent planarizing film interposed therebetween.

17. The method of claim 16, wherein
a photomask, which is used to form the wall portion in the step (b), is also used to form the plurality of microlenses in the step (d).

18. The method of claim 17, wherein
the wall portion is formed from a negative resist, and
the plurality of microlenses are formed from a positive resist.
